(19) United States
(12) Patent Application Publication
(10) Pub. No.: US 2005/0225013 A1
(43) Pub. Date: Oct. 13, 2005

(54) Method for the production of hybrid spherical molded bodies from soluble polymers

(76) Inventors: Thomas Schulze, Rudolstadt (DE); Tassillo Moritz, Dresden (DE)

Correspondence Address: Horst M Kasper, 13 Forest Drive, Warren, NJ, 07059, US

(21) Appl. No.: 10/514,867

(22) PCT Filed: May 14, 2003
(86) PCT No.: PCT/DE03/01559

§ 371 Date: May 10, 2005

(30) Foreign Application Priority Data
May 15, 2002 (DE) 102 21 537.5

(51) Int. Cl. C04B 33/32

(52) U.S. Cl. 264/621; 106/163.01

(57) ABSTRACT

The invention relates to a method for producing hybrid spherical molded bodies from soluble polymers and at least one embedded additive in that an additive-loaded polymer solution is dispersed in an inert solvent, and said dispersion process is carried out at a reduced pressure, the resulting particle dispersion is cooled below the solidification point of the polymer solution, the stabilized particles of the polymer solution are separated from the inert solvent, the separated particles of the polymer solution are precipitated in a solvent coagulating the polymer, the solvent-moistened polymer particles are subjected to a drying process until maximal densification is obtained, and the resulting particles that are made of polymer and additive are sintered by way of a thermal treatment to yield porous and/or highly condensed molded bodies. Resulting therefrom are highly stable molded bodies which do not sinter together during sintering process.

The method according to the invention relates to the production of regular cellulose and/or ceramic, preferably spherical molded bodies in a range of particle sizes of from 1 μm-1000 μm by dispersing solutions of cellulose in organic solvents in liquid, inert carries media and in subjecting the resulting molded bodies to a thermal treatment.

### PRIOR ART

Small-dimensioned particles in all classes of sizes have acquired a firm place in innumerous industrial applications in the last decades. Today a great number of inorganic materials is commercially available, apart from a plurality of polymer matrices. The multitude of possible applications in industrial processes of biotechnology, separation techniques and modern reaction technique permanently opens new fields for these materials.

Not only the kind of the substances used but also their form are challenging further developments. So there is an increasing demand for ideal spherical particles, which may satisfy the demand for, for example, an optimal packaging in fillings or a uniform whirling behavior in whirling layers. Moreover, as concerns large dimensioned columns, the pressure constancy is of decisive importance. The manufacture of small-dimensioned spherical inorganic particles is carried out by the most diverse manufacturing methods. Basically, there are two mainstreams dominating: on the one hand, the bead formation via dispersing of filled polymer solutions, on the other hand, the processing of sols and gels with a subsequent calcinations. So, for example, according to EP 1108698 and EP 0353669, ceramic powder, bound to polymers, is worked into aqueous mash and this being dispersed with a liquid which is immiscible with water. Further applications (U.S. Pat. No. 5,384,290, EP 0300543, EP 0369638) describe the bead formation by use of foamable pre-polymers; the beads themselves after formation are used for solidifying the structure. Furthermore, a great number of patents based on the sol-gel-techniques gives evidence of the importance of this on the sol-gel-techniques gives evidence of the importance of this technology for producing ceramic molded bodies (for example, U.S. Pat. No. 5,064,783, EP 0745557).

As to a fidelity of shape and the simplicity of processing the conventional standard forming technologies via, for example, polymeric bound suspensions of particles are up-to-now no practicable alternative, since the particle size is strongly limited towards smaller sizes due to process inherent factors. Further known polymer forming technologies such as melting/solidifying (polyamide) or chemical modification/regeneration (viscose process, carbamat process) do not permit such high a loading of additives which is required for a form-stable processing. Sol-gel technologies cannot ensure a sufficient form stability in the aimed at range of particle diameters since hereby the transition from the stabilized gel state into, for example, the oxidic ceramic is accompanied by high bulk losses and resulting high porosity. With respect to simplicity and efficiency the Lyocell technology has proven to be extraordinarily suitable. As already described in DE 197 55 352 C1 and DE 197 55 353 C1 technologies such as the dispersing of cellulose solutions in inert carrier material, which do not precipitate cellulose, or the beam cutting of cellulose solutions will yield spherical particles over a wide range of particle sizes.

Furthermore, in DE 199 10 012 C1 (WO 00 538 33) there was set out that solutions of cellulose in N-methylmorpholin-N-oxid-monohydrate has a very large admission capacity for foreign matter. Thereby load rates of cellulose/additive of more than 1:5 can be realized with additives of high density. Such solutions still show a very good capability for filament formation even with loads being a multiple of the cellulose weight and, hence, can be extruded to elongated molded bodies (fibers, filaments) or molded to plastic foils without problems. The forming of materials of different kind which themselves, at low temperatures, do not exhibit the possibility of deformation (metals, for example) or do not have such material properties which would permit a self-deformation due to missing plasticity (for example, low-molecular crystalline compounds, ceramic powders) are, however, not described in the prior art mentioned.

### OBJECT OF THE INVENTION

It is an object of the invention to provide a method which permits such a (de)formation of various materials and thereby solves, above all, the problem of stability at thermal treatment, since too low a package density can result in a structural break-down, particularly after pyrolysis of the binder. Furthermore, density gradients, which are due to an inhomogeneous package of particles and included air-bubbles, result in considerable variations in strength of the sintered final products und are potential sites of fractures, particularly in high-strength ceramic molded bodies. Closely connected therewith is the object so ensure that the molded particles will not be subjected in the subsequent processing steps to further variations in form, apart from the beginning shrinkage.

This object is realized in that a soluble polymer from the group of the polysaccharides, preferably cellulose, together with the respective additives, organic or inorganic, low-molecular or high-molecular, thermally stable or decomposable and capable of being sintered such as, for example, ceramic powder, is dissolved (dispersed) in N-methylmorpholin-N-oxid mono-hydrate, which is immiscible with the solution, does not affect the cellulose in precipitating the same and does not undergo a chemical interaction with the cellulose and the additives and all that, according to the invention, being carried out under a reduced pressure, subsequently the resulting dispersion is cooled, whereby the solution drops solidify, the solidifying solution drops are entirely separated from the carrier medium, the polymer solution being formed in this manner is brought into a precipitating medium, whereby the pre-shaped spherical form of the solution drops is permanently stabilized, the resulting highly swelled particles are, if desired, impregnated with compounds being solved in water or in organic solvents, and, according to the invention, the drying of the solvent-moistened polymer particles is continued until said particles are maximally condensed, and/or the resulting filled particles are subjected to a thermal treatment.

In the method according to the invention the advantages of the above described bead formation by Lyocell technology and the possibility of highly overloading the cellulose solutions are combined with one another. There was surprisingly found that also highly filled solutions with loading rates of a cellulose-additive-ratio of 1:7 (parts of weight) can be formed to spherical molded bodies of high stability, when an extrusion of the solution by annular nozzles or slit nozzles meets its ultimate limits. Furthermore there was found that the molded bodies maintain their form stability in the subsequent steps of processing, particularly in the thermal treatment, will stand the burning out of the supporting cellulose matrix (release) even in multiple layers under the effect of the own weight of the feed and subsequently they can be densified nearly up to the theoretical density of the respective additive by a sintering process.

As already described in DE 199 10 012 C1 the required cellulose solutions will be produced from air-dry cellulose, an aqueous solution of N-methylmorpholin-N-oxid and the respective additive. All such substances are suitable for additives that are mechanically disintegrated fine enough or will dissolve in the course of the process of producing the solution, that do not undergo any interaction with the organic solvent, the cellulose or the water, that will stand the exclusively aqueous processing without any changes and will not be exhausted to much by the extraction processes, and will have a sufficient sintering activity in the case of application of ceramic molded bodies. In the case of inorganic filled molded bodies, a loading ratio can be set of cellulose:additive=1:1 up to 1:8, preferably between 1:3 and 1:6 in dependence on the density of the material used and the respective application. This ratio can be varied in as much as it is permitted by the stability of the molded bodies after their release, 15 weight-% cellulose being the supporting matrix for 85 weight-% additives at a ratio of, for example, 6 parts additive to 1 part cellulose. Thus, the density of the molded bodies can be set in a simple manner via the degree of loading. High degrees of loading will result in densities which will be scarcely achieved by other non-pressure ceramic formation processes at formations bound to polymers (slip molding). With low loadings, on the other hand, there will be formed an open-pore mesh after the burning out of the supporting cellulose, whereby the mesh can be sintered to porous molded bodies with the porosity being pre-settable. Furthermore, there are mixtures of additives possible which, for example, improve the sintering activities, undergo reactions during the thermal treatment, for example, the formation of catalytic active metal layers or themselves react with the additives, for example, a formation of mixed phases. When adhering to the above mentioned conditions, it is also possible to work in compounds which only form stable phases when under thermal stress or will be anchored generally in the polymer mesh for a later application without that a pyrolysis of the supporting polymers is carried out.

The viscosity of the cellulose solution is very strongly affected by the concentration of the cellulose and by the additives. In the method according to the invention there are cellulose solutions used which have concentrations of cellulose of from 1.5 to 15 weight-%, preferably 3-9 weight-%. Additionally, there is a strong increase in viscosity at high degrees of loading, the increase in viscosity having a decisive influence on the subsequent dispersing and on the spectrum of particles obtained therewith. In the method according to the invention, the loaded cellulose solutions are molded in a solvent at increased temperatures to spherical structures. To obtain this, all liquids are suitable which do not result in an immediate precipitation of the cellulose (water, alcohol) or to an extraction of the organic solvents (DMF, acetic ester) and which can form a stable dispersion with the solution. Mineral oil, silicone oil, native vegetable oil, waxes and paraffin as well as mixtures of biphenyl and biphenyl ether have proven useful.

The solution drops are finely dispersed into the carrier medium by applying mechanical energy, taking on an ideal spherical form. Such forms of stirrers are suited thereto, which exhibit a low shearing action in the stirring zone, but ensure a fine vortex bale formation, for example, propeller stirrers, blade stirrers, and horseshoe stirrers. There was surprisingly found, that even extremely viscous solutions had safely be transformed into beads by applying low mechanical energy and had been kept in stable dispersions. The speed of rotation to be used depends on the density of the solution und of the carrier medium and lie in a range of between 100 and 10.000 rpm, preferably between 250 and 3000 rpm. The ratio of mixture (loading of the carrier medium with cellulose solution) can be between 0.01 and 0.5, preferably between 0.07-0.4. The dispersing temperature should be above the melting point of the cellulose solution, but it could fall below the same with short time dispersing. The dispersing will preferably be carried out at 75 to 100° C. The spherical particles will be obtained in a range sizes between ?10 and 1000 μm, preferably ?50-500 μm, depending on the stirring parameters, the pressure in the stirring vessel, the ratio of mixture, the temperature, and the properties (loading, viscosity) of the cellulose solution. As it generally known, there happens in spite of countermeasures a drag-in of gas into the dispersion with numerous dispersing processes due to surface turbulences. According to the invention this problem is avoided in operating at a reduced pressure. Thereby the cellulose solution as well as the carrier medium is continuously degassed before and during the dispersion so that no gas bubbles will enter the beads during the solidification phase.

When the dispersion is then, under stirring, cooled below the solidification temperature of the cellulose solution, the spherical form is maintained at first. After separating the carrier medium, in the simplest way by decantation and filtration, the form stabilization is carried out by coagulation in a precipitating agent, preferably water, which, if required, is provided with additives. In order to modify the precipitation inferior alcohols may be used. The filled cellulose beads produced in such a manner represent highly soaked structures of amorphous cellulose, wherein the additives are finely distributed. In this processing step, and if required, an additional impregnation with modifying agents can also be carried out. This will be advantageous particularly when the respective material is water-soluble or otherwise incompatible with the used amine solvent. Thus considerable amounts of compounds can be embedded in the cellulose mesh afterwards, or additives that are already present may be modified. Here, in particular, it is thought of an impregnation with metallic salt solutions or sols, but also, in the simplest case, of an elution with solved organic compounds, if required after an exchange of the solvent.

In the subsequent drying step, a strong enrichment of additives is achieved and, due to the beginning shrinkage of the cellulose, to a considerable densification. Surprisingly there was found that in the course of this shrinkage process the form of the particles, which had been set in the dispersing process, was maintained. In addition to the consolidation of form and densification, even water-soluble additives are now securely bound within the now crystalline cellulose matrix, which is a considerable advantage in, for example, controlled-release applications of agents. This phenomenon results therefrom that the transition from the amorphous to the crystalline cellulose is accompanied by an irreversible crystallization, whereby the compounds when having been embedded will now be stronger bound to the mesh than would have been obtained by an impregnation of, for example, soaked cellulose.

The separation of the spherical particles will be achieved either by wet sifting, more preferably by dry sifting, or by air-separation into grain sizes of defined composition. By selecting the stirring parameters the obtained particle spectrum can be narrowly distributed so that there are only minor efforts necessary for separation.

The obtained spherical molded bodies are composites of preferably cellulose with additives and are ready for further applications and processing, respectively, in this form.

They will be substantially used as green bodies for the manufacture of ceramic beads which can find applications as grinding granules, chromatographic carrier media, catalyst supports, and beads being capable of heat sterilization in medical applications. Moreover, additive-loaded pure cellulose beads have a great potential for use in, for example, controlled-release applications, when releasing agents in the medical field.

The invention will be explained in more detail by the following examples.

### EXAMPLES

### Example 1

Into 500 g of a 50% aqueous solution of N-methylmorpholin-N-oxid 20 g of a cotton-Linters-pulp (DP 477) and 100 g aluminum-oxide (d₅₀=0.7 °m) are given. Under intensive kneading water is distilled off in vacuum at 50 millibar at 85° C. as long until a homogenous viscous solution results. The still liquid cellulose solution is coated with 927 g viscous paraffin oil (100 mPa.s) and stirred with a propeller stirrer for 5 min at 1500 rpm. Then a quick cooling is carried out under constant stirring until the solution, which is transformed into beads, solidifies. After depositing decantation is performed, superfluous oil is sucked off and subsequently precipitation is carried out in warm water. After several washing treatments with hot water still adherent residues of oil will be removed by hot extraction with ?tertiary butanol and subsequently mildly dried. There will result highly filled beads with a portion of 83% filling material and in a diameter range of 100-500 μm. The burning-out of the cellulose and a subsequent sintering at 1450° C. will yield dense and hard corundum beads.

### Example 2

11.3 kg silicon oil (250 mPa.s) are received in a heatable stirring vessel at ambience. There into 2 kg of a solid 8 weight-% cellulose solution are given which is filled in a ratio of cellulose:titanium dioxide=1:8. The system is air-tightly sealed and heated to 90° C. After the solution is entirely melted, it will be stirred for 30 min. at a speed of rotation of 800 rpm at a pressure of 0.1 mbar and, after turning off the heating, the speed of rotation is stepwise increased to 2000 rpm until solidification. The obtained beads are filtered off, precipitated in hot water, and washed three times with hot water. Residuals of silicon oil are removed by washing with ethanol. The subsequent drying yields TiO₂-filled beads having a titanium dioxide percentage of 89%. The diameters of the particles lie between 20 and 150 μm. The thermal treatment at 1800° C. results in ceramic beads of titanium dioxide.

### Example 3

5 kg of an eutectic mixture consisting of biphenyl ether and biphenyl are filled up with 2.3 kg of a solution consisting of 102 g cellulose (Cellunier F), 1950 g N-methylmorpholin-N-oxid monohydrate and 255 g boron carbide (d₅₀=1 μm) and heated to 75° C. The melted solution is dispersed by a 4-blade stirrer and an ultrasonic horn within 10 min. at 1 mbar and, after turning off the ultrasonic transmitter, quickly cooled to 20° C. under stirring, whereby a solidification of the molded particles starts. After depositing they are filtered at 40° C. and the filter cake is washed again with isopropanol. The precipitation is carried out in warm water and after several extractions of any still adhering solvent the molded beads can be dried. After a non-pressure sintering at 1800° C. dark colored hard beads of boron carbide will form.

### Example 4

By way of a piston spinning device, 513 g of a cellulose solution which consists of 75% N-methylmorpholin-N-oxid monohydrate, 8.5% cellulose, and 16.5% zirconium oxide, are injected within 30 min. into 2 kg of highly viscous paraffin oil, which is thermostated to 25° C., under heavy stirring (3000 rpm) and under a pressure of 0.5 mbar. Thereby a solidification of the forming spherical particles takes place, which are sucked off and are coagulated in warm water. After repeated washing with water and ethanol a mild drying is carried out. Beads of cellulose with embedded zirconium oxide particles in a range of sizes of from 100 to 700 μm will be obtained. After debinding and sintering hard and pressure-stable spheres of zirconium oxide will result.

### Example 5

Spherical molded bodies within a range of diameter of ?50-250 μm are produced under a pressure of 5 mbar and stirring in warmed paraffin oil from a 7.5 ?weight-% solution of cellulose, which contains one weight percentage cellulose to one weight percentage aluminum oxide. These bodies are separated from the carrier medium, coagulated and released from the paraffin residuals by a repeated washing and final extraction. The still moist beads are placed for 30 min. in a 5 weight-% solution of hexa-chloroplatinic acid, filtered off and dried. After debinding and sintering under atmospherical air porous beads of aluminum oxide with embedded finely distributed platinum oxide are obtained.

### Example 6

Cellulose beads were made according to DE 197 55 352 C1 from a 6 weight-percent cellulose solution, which contains 10 weight-percent glucose, under a pressure of 0.1 millibar. After precipitation and extraction the moist beads are treated for 10 min. with a concentrated solution of nickel sulfate and subsequently dried. The thermal treatment is carried out under exclusion of oxygen in an inert gas stream. Thereby porous particles are formed with embedded finely distributed parts of nickel oxide.

### Example 7

200 g of a 7.5 weight-percent cellulose solution, which contains 30 weight-percent of starch, are melted in 2300 g highly viscous paraffin oil at 80° C. and subsequently distributed into fine solution drops by a propeller stirrer for 15 min at a pressure of 0.01 millibar. The deposited suspension of particles is separated, de-oiled and coagulated in warm water. After the extraction with ?tertiary butanol the moist cellulose beads will be immersed in a 10 weight-percent solution of acetosalicyclic acid in aqueous ethanol for 120 min., filtered off and subsequently dried. Form stable cellulose beads with embedded acetosalicyclic acid will result.

1. Method for producing hybrid spherical molded bodies from soluble polymers from the group of polysaccharide (starch, dextran), preferably cellulose and at least one embedded additive, in that the additive loaded polymer solution is dispersed in an inert solvent, the resulting particle dispersion is cooled to a temperature below the solidification point of the polymer solution, the stabilized particles of the polymer solution are separated from the inert solvent, the separated particles of the polymer solution are precipitated in a solvent coagulating the polymer,
characterized in that
a) the dispersing process is carried out at a reduced pressure,
b) the solvent-moistened polymer particles are subjected to a drying process until the maximal densification is obtained, and
c) the formed particles out of polymer and additive are sintered to porous and/or highly condensed molded bodies under thermal treatment.

2. Method as claimed in claim 1, characterized in that the dispersion process is carried out in vacuum between 10⁻⁴ and 100 millibar, preferably between 0.01 and 1 millibar.

3. Method as claimed in claims 1 and 2, characterized in that the stirring process is performed entirely or partially under vacuum.

4. Method as claimed in one of the claims 1 to 3, characterized in that the polymer is solved in an amino solvent, preferably in N-methylmorpholin-N-oxid.

5. Method as claimed in one of the claims 1 to 4, characterized in that the polymer solution contains at least one additive in the range of 0.01 to 1000 weight-%, preferably between 5 and 700 weight-%, related to the part of the polymer.

6. Method as claimed in one of the claims 1 to 5, characterized in that the additive/s is/are heavily soluble or insoluble in the inert solvent.

7. Method as claimed in one of the claims 1 to 6, characterized in that the additive/s is/are organic or inorganic, low-molecular or high-molecular, thermally stable or decomposable and capable of sintering such as, for example, ceramic powder.

8. Method as claimed in one of the claims 1 to 7, characterized in that the additive/s has/have a size of particles of from 10 μm to 1000 μm, preferably 50 μm to 5 μm.

9. Method as claimed in one of the claims 1 to 8, characterized in that the inert solvent is from the group of the saturated aliphatic or unsaturated aromatic hydrocarbon, from the saturated and unsaturated fatty acid esters and linear as well as cyclic polysiloxane.

10. Method as claimed in claims 1 and 9, characterized in that stirrer systems in the range of rotation numbers of between 10 and 20.000 rpm are employed for the energy input when forming the spherical particles from the solid loaded polymer solution.

11. Method as claimed in one of the claims 1 to 10, characterized in that the dispersion is cooled down to a temperature of from 60 to 10° C., preferably 0 to 10° C. for stabilizing the spherical molded bodies.

12. Method as claimed in one of the claims 1 to 11, characterized in that the coagulating medium is preferably water.

12. Method as claimed in one of the claims 1 to 11, characterized in that the coagulating medium is preferably water.

13. Method as claimed in one of the claims 1 to 12, characterized in that the supporting polymer matrix is pyrolized without residue at the thermal treatment.

14. Method as claimed in at least one of the claims 1 to 13, characterized in that the porous or dense molded bodies can include one substance or more with inherent functional properties such as, for example, electric, magnetic, or catalytic activities.

15. Method as claimed in at least one of the claims 1 to 14, characterized in that a second or further substance/s is/are worked into the polymer solution prior to dispersing.

16. Method as claimed in at least one of the claims 1 to 15, characterized in that the second or further substance/s is/are afterwards worked into the still solution-moistened spherical molded bodies.
